(19) United States
(12) Patent Application Publication
(10) Pub. No.: US 2014/0149161 A1
(43) Pub. Date: May 29, 2014

(54) LEAD DISTRIBUTION

(71) Applicant: Velocify, Inc., El Segundo, CA (US)

(72) Inventor: Nicholas Hedges, Santa Monica, CA (US)

(73) Assignee: Velocify, Inc., El Segundo, CA (US)

(21) Appl. No.: 14/091,876

(22) Filed: Nov. 27, 2013

Related U.S. Application Data
(60) Provisional application No. 61/730,675, filed on Nov. 28, 2012.

(51) Int. Cl. G06Q 10/06

(52) U.S. Cl. CPC G06Q 10/063112
USPC 705/7.14

(57) ABSTRACT

A system for scoring and distributing sales leads. A scoring model may score sales leads based on attributes of the leads and the likelihood of the lead resulting in a desired outcome. The scoring model may be updated based on new information about the outcome of sales leads, or in response to a determination that the scoring model is not providing adequate accuracy. A distribution module may distribute sales leads to sales entities. The entities may be assigned to tiers which determine the manner in which leads are distributed. The assignment of entities to tiers may be updated based on changes in the attributes of the sales entities.

### CROSS-REFERENCE TO RELATED APPLICATIONS

This application claims priority from provisional U.S. Pat. App. No. 61/730,675 filed on Nov. 28, 2012, which is hereby incorporated by reference in its entirety.

### BACKGROUND

This disclosure relates to the field of sales lead evaluation and distribution. Sales leads provide businesses a list of potential consumers. Consequently, leads provide a more efficient way to identify consumers that are more likely to be future customers of an organization, rather than simply blanketing all possible consumers.

In companies with large sales divisions, not all sales agents perform at the same level. For example, some sales agents are more likely than others to make a sale on a particular product. Furthermore, some leads are stronger than other leads. For example, one lead may indicate a person ready to purchase a particular product, while another lead may indicate only that a person has visited that company's website.

### SUMMARY

Some embodiments may comprise a computing system with one or more hardware computer processors and one or more storage devices. The storage devices may be configured to store software instructions configured to cause one or more hardware computer processors to perform a number of operations. These operations may include determining one or more attributes of a sales lead. The processors may also access parameters of a plurality of distribution programs. The distribution parameters may include one or more lead attributes which are required of sales leads to be eligible for the distribution program, tier configuration attributes indicating the number of tiers in the distribution program, and the membership requirements for sales entities to be assigned to tiers. The distribution parameters may also include one or more distribution models which determine the manner in which leads will be distributed to distribution tiers and/or distribution entities. For example, a lead distribution model may distribute consecutive sales leads to sales agents in different tiers. The computer processors may also perform the operation of selecting a distribution program with required lead attributes matching the one or more attributes of a sales lead. The computer processors may also distribute sales leads to a tier of sales agents based on a selected lead distribution model and a lead distribution model associated with the lead distribution program.

Some embodiments may comprise a computing system with one or more hardware computer processors and one or more storage devices. The storage devices configured to store software instructions configured to cause one or more hardware computer processors to perform a number of operations. These operations may include receiving parameters from a user. The parameters may include the desired outcome of a sales lead, and one or more of a score range, a selection or category of leads to include, or categories of leads to exclude. The computer processors may also access attributes of one or more historic leads which fit the parameters received from the user. The historic sales leads are associated with an outcome from previous communications with a consumer identified in the historic lead. The processors may then generate a scoring model based on the historic leads and the attributes associated with the historic leads. The scoring model predicts the likelihood of communication with the consumer identified in the sales lead leading to the desired outcome received from the user. The processors may then access a new sales lead and determine a score by applying the scoring model to the new sales lead. The processors may also determine a score power for the lead score. The score power indicates the accuracy of the lead score as an indication of the likelihood of communications leading to the desired outcome. The processors may then provide one or more of the sales lead, the lead sore, or the lead score power.

### BRIEF DESCRIPTION OF THE DRAWINGS

FIG. 1 is a flowchart illustrating a high-level overview of a lead system.

FIG. 2 is a sample block diagram representing hardware and/or software components of an example embodiment.

FIG. 3 is a flowchart showing a lead system with a lead scoring system and a lead distribution system.

FIG. 4 is an example of a Heuristic Scoring Method.

FIG. 5A is a lead scoring flowchart wherein a scoring model may be updated periodically or in response to a trigger event.

FIG. 5B is a lead scoring flowchart where a predictive score power is used to determine when to update a scoring model.

FIG. 6 is a lead distribution system flowchart.

FIG. 7 is a flowchart showing a method for selecting a lead distribution program.

FIG. 8A is a flowchart comparing across tier distribution to allocation by tier distribution.

FIG. 8B is a flowchart demonstrating distribution of leads to multiple distribution programs.

### DETAILED DESCRIPTION

### Overview

In view of the varying value of leads and/or capabilities or experiences of sales agents, described herein are automated systems that track performance of sales agents, and predict the quality of a lead before the lead is distributed to a sales agent, allowing more efficient distribution of leads. Accordingly, embodiments of the lead system disclosed herein may be beneficial to companies wishing to contact leads in the most efficient manner possible with the goal of maximizing sales productivity.

The lead systems disclosed herein may comprise a lead scoring system and/or a lead distribution system as well as other systems. The lead scoring system may evaluate leads based on attributes associated with each lead and associate a score to the lead based on that evaluation. The evaluation may be done automatically as part of a computer system, such as based on inputs from a user. In some embodiments, more than one score is associated with each lead. When a sales entity accesses a lead, the entity can see the lead and the scores associated with the lead, and use the scores in distributing leads, for example.

The lead distribution system distributes leads to sales entities, such as sales agent, agent groups, or departments, for example. In some embodiments, the lead distribution system places sales agent into performance tiers, and distributes leads based on those tiers. The lead distribution system may assign sales entities to tiers based on other attributes of the entities as well. When leads are distributed, more leads may be distributed to agents in some tiers than in other tiers. The lead distribution system may also assign agents to a particular priority within a tier and distribute leads to those agents with the highest priority first within the tier.

### DEFINITIONS

In order to facilitate an understanding of the systems and methods discussed herein, a number of terms are defined below. The terms defined below, as well as other terms used herein, should be construed to include the provided definitions, the ordinary and customary meaning of the terms, and/or any other implied meaning for the respective terms. Thus, the definitions below do not limit the meaning of these terms, but only provide exemplary definitions.

Lead: any set of data that represents an entity that may generate new revenue for an organization. A “lead,” as used herein may also refer to an individual (or other entity) identified in the lead, rather than the data associated with the individual. For example, a business may purchase a lead (e.g., a set of data or lead attributes associated with an individual, such as demographic and contact information) for purposes of attempting to sell a product or service to the lead (e.g., the individual identified in the lead data). A lead may be associated with an individual, household, business, and/or other group of individuals that is unknown to the organization, or may be an existing or past customer. Lead attributes may include name, street address, city, state, ZIP, age, gender, credit score, income, household income, expenses, debts, assets, product or service of interest, organizational budget, spending authority level of the individual, purchase decision timeframe, previous purchase history, electronic and telephonic interaction history, or any other attribute which provides information about the lead.

Lead Scoring: methods for allocating an attribute, such as a lead score, to a lead intended to signify its quality (or many qualities) in comparison to other leads. For example, a lead score could indicate a likelihood that a lead will convert (e.g., purchase a product offered by the organization). A lead may have multiple lead scores that signify different qualities regarding the lead.

Lead Distribution: methods for allocating leads to an entity (e.g., an individual sales agent or group of sales agents) within an organization versus other entities in the organization. The entity could be an individual (typically but not necessarily a sales representative or agent) or a group (such as a sales team comprising multiple sales agents).

Distribution Program: parameters usable to determine how to distribute leads. A distribution program may be selected (or created) for each marketing campaign of a company (e.g., for a particular product, service, poll, etc. or group of the same), for example, or may be used for multiple marketing campaigns of a company and/or of multiple companies. A distribution program may include various parameters that are used in determining how to allocate sales leads to sales entities. The parameters may include one or more attributes required of sales leads to qualify for distribution; tier configuration attributes indicating a quantity of tiers, requirements for membership of sales entities within tiers, and/or other information regarding groupings of sales entities; a lead distribution model (or method) indicating in what manner incoming leads are distributed among tiers and/or among sales entities within tiers; and/or other constraints on the distribution of sales leads.

### Example System Overview

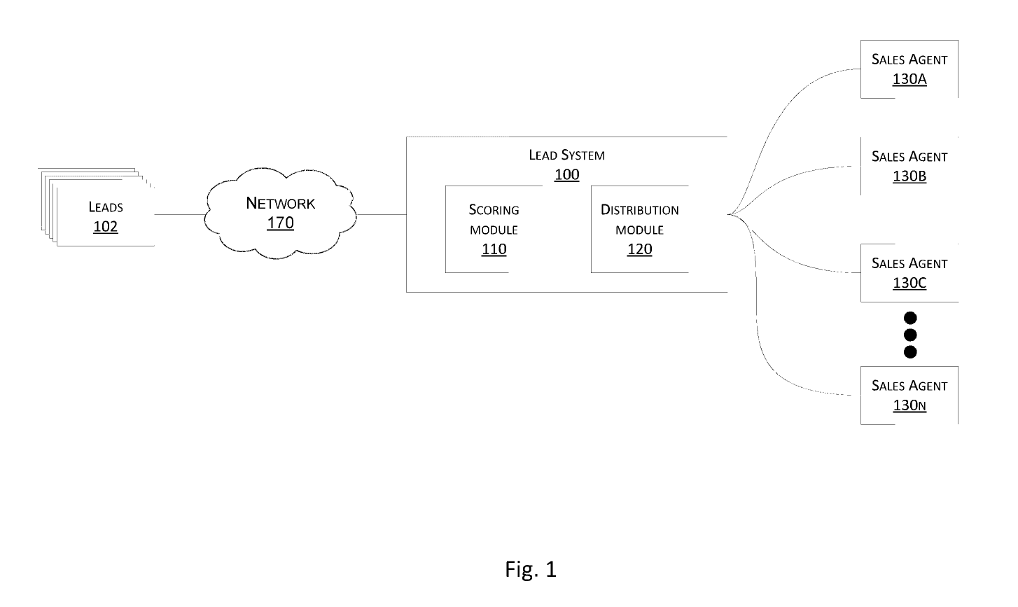

FIG. 1 is a block diagram illustrating an exemplary lead system that receives leads 102, scores the leads, and distributes the leads amongst multiple sales agents 130 (or other entities). The leads 102 may include one data file for each lead or a single data file that includes multiple leads. Leads may be included in any data structure, such as in an XML, CSV, TXT, or other spreadsheet, text, or web accessible data structure.

In the embodiment of FIG. 1, the lead system 100 comprises one or more computing devices (e.g., a network server) configured to score and distribute leads to the sales agents 130 (or other entities in alternative embodiments). As shown in FIG. 1, the lead system 100 includes a scoring module 110 (or a separate lead system in some embodiments) and a distribution module 120 (or a separate distribution system in some embodiments). In this embodiment, the scoring module 110 is configured to score leads 102 in order to provide one or more lead scores (and/or other value metrics) to respective leads. The scores may then be used by the distribution module 120 in order to assign respective leads to particular sales agents 130 (including sales agents 130A, 130B, 130C, and any quantity of sales agents through 130N). As discussed further below, the distribution module 120 in some cases distributes leads based not only on lead scores but also on tier assignments of respective sales agents, where sales agents may be assigned to tiers based on one or multiple factors associated with the particular sales agent. In the embodiment of FIG. 1, lead system 100 accesses leads through a network 170, which comprises one or more of any available networks, such as one or more local area networks (LAN), personal area network (PAN), wide area network (WAN), or the Internet, for example. In some embodiments, lead system 100 may also distribute the leads to sales agents 130 through the network 170.

### Example System Architecture

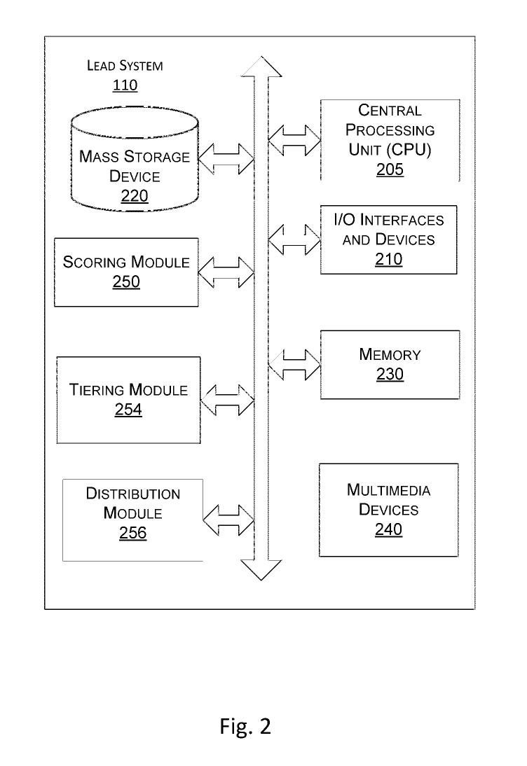

FIG. 2 is a block diagram illustrating one embodiment of the lead system 100. The lead system 100 may be operated by a provider of the various modules 250, 254, 256 (e.g., as a cloud based service that provides scores and/or distribution information to one or more organizations) or by an organization that uses the leads, such as in the form of installable software that the organization installs in order to score and distribute leads.

In one embodiment, the lead system 100 is configured to interface with multiple devices and/or data sources, such as in the example network configuration shown in FIG. 1. The lead system 100 may be configured to implement certain systems and methods described herein. For example, in one embodiment the lead system 100 may be configured to access leads, scores leads, assign agents to tiers, distribute leads to agents, and/or other related tasks. The functionality provided for in the components and modules of the lead system 100 may be combined into fewer components and modules or further separated into additional components and modules. For example, in one embodiment the scoring module 250 is executed on a computing system different than a computing system that executes the distribution module 256 and/or tiering module 254.

In general, the word module, as used herein, refers to logic embodied in hardware or firmware, or to a collection of software instructions, possibly having entry and exit points, written in a programming language such as, for example, C, C++, C#. A software modules may be complied and linked into an executable program, installed in a dynamic link library, or may be written in an interpreted programming language such as, for example, BASIC, Java, Perl, or Python. It will be appreciated that software modules may be callable from other modules or from themselves or may be invoked in response to detected events and interrupts, or both. Software instructions may be embedded in firmware, such as an EPROM. It will be further appreciated that hardware modules may be comprised of connected logic units, such as programmable gate arrays or processors. The modules described herein are preferably implemented as software modules, but may be represented in hardware or firmware. Generally, the modules described herein refer to logical modules that may be combined with other modules or devices into sub-modules despite their physical organization or storage.

In one embodiment, the lead system 100 includes, for example, one or more servers or personal computers that are IBM, Macintosh, or Linux/Unix compatible. In another embodiment, the lead system 100 includes one or more laptop computers, smart phones, personal digital assistants, or other computing devices. The lead system 100 may include a memory 230, which may include a random access memory (“RAM”) for temporary storage of information, a read only memory (“ROM”) for permanent storage of information, and/or a mass storage device, such as a hard drive, diskette, optical media storage device, or USB flash drive. Typically, the modules of the monitoring system are in communication with each other via a standards based bus system 180. In different embodiments, the standards based bus system could be Peripheral Component Interconnect (PCI), Microchannel, SCSI, Industrial Standard Architecture (ISA), and Extended ISA (EISA) architectures, for example.

The lead system 100 may be generally controlled and coordinated by operating system software, such as Windows 95, 98, NT, 2000, XP, Vista, 7, 8, SunOS, Solaris, Blackberry OS, or other compatible operating systems. In Macintosh systems, the operating system may be any available operating system, such as MAC OS X. In other embodiments, the lead system 100 may be controlled by a proprietary operating system. Conventional operating systems control and schedule computer processes for execution, perform memory management, provide file systems, networking, and I/O services, and provide a user interface, such as a graphical user interface (“GUI”), among other functions.

The example lead system 100 shown in FIG. 2 includes one or more commonly available input/output (I/O) interfaces and devices 210, such as a keyboard, mouse, touchpad, and printer. In one embodiment, the I/O interfaces and devices 210 include one or more display devices, such as a monitor, that allow the visual presentation of data to a user. More particularly, a display device provides for the presentation of GUIs, application software data, and multimedia presentations, for example. The lead system 100 may also include one or more multimedia devices 240, such as speakers, video cards, graphics accelerators, and microphones, for example. In one embodiment, the I/O interfaces and devices 210 comprise devices that are in communication with modules of the lead system 100 via a network, such as the network 170 (FIG. 1), or any local area network, including secured local area networks, or any combination thereof.

In the embodiment of FIG. 2, the lead system 100 also includes modules that may be executed by the CPU 205. In the embodiment of FIG. 2, the lead system 100 includes a scoring module 250, a tiering module 254, and a distribution module 256. In this embodiment, the scoring module 250 is configured to analyze data associated with respective leads and assign one or more lead scores to each, where the lead scores indicate one or more values of the leads. The tiering module 254 is configured to assign entities that will use the leads (e.g., sales agents that contact the leads) to various tiers, based on attributes of the entities, such as previous sales performance, contact rates, availability, etc. The distribution module 256 is configured to distribute the leads, both in real time as leads are received and at certain times based on triggers associated with the occurrence of sales workflow events such as phone calls being made or appointments being set, based on lead scores and tiers of sales agents. Functionality of these modules is discussed further in the description below.

### Example Lead Scoring and Distribution Methods

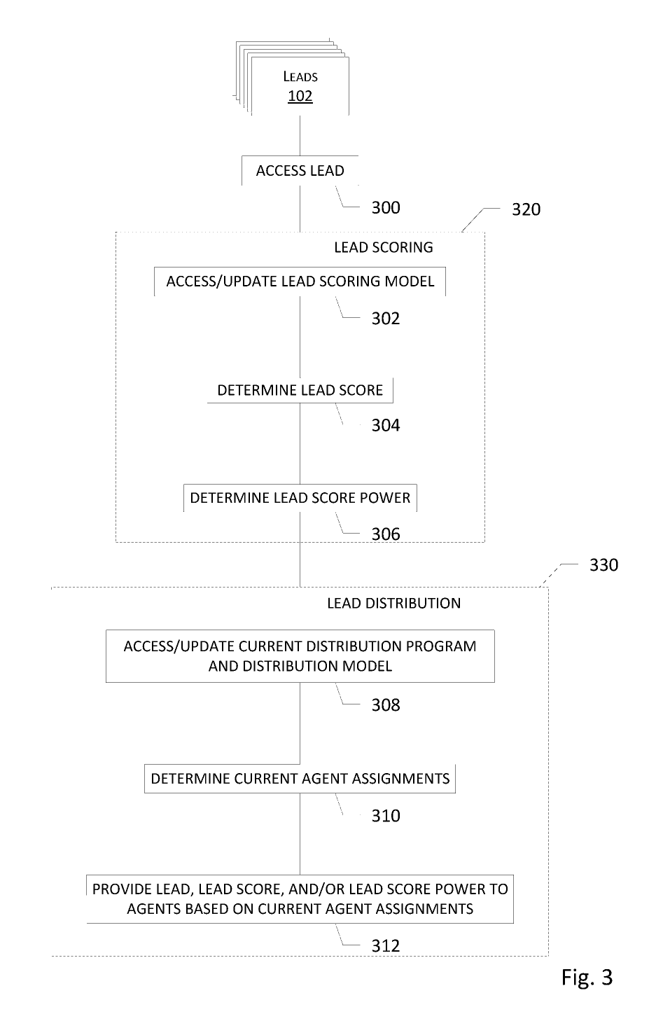

FIG. 3 is a flowchart illustrating an embodiment of a lead system 100 (FIG. 1) including a lead scoring system 320, a lead distribution system 330. As noted above, other lead systems may include only one of the lead scoring or lead distribution systems. Depending on the embodiment, the method of FIG. 3 may have fewer or additional blocks and/or the blocks may be performed in a different order than shown. For instance, in some embodiments, block 306 is not performed and a lead score is provided by the system without an evaluation of the score's power.

Beginning at block 300, the lead system 100 accesses leads, such as by accessing a data structure (e.g., a database, flat file, CSV file, XML file, etc.) that stores the lead attributes. The method of FIG. 3 includes blocks that may be performed by multiple modules and/or systems. For example, the lead scoring system 320 may include a scoring model generation module and a score calculation module. In the embodiment of FIG. 3, blocks 302, 304, and 306 illustrate processes which may be performed by modules of a lead scoring system, which blocks 308, 310, 312 illustrate processes which may be performed by modules of a lead distribution system 330.

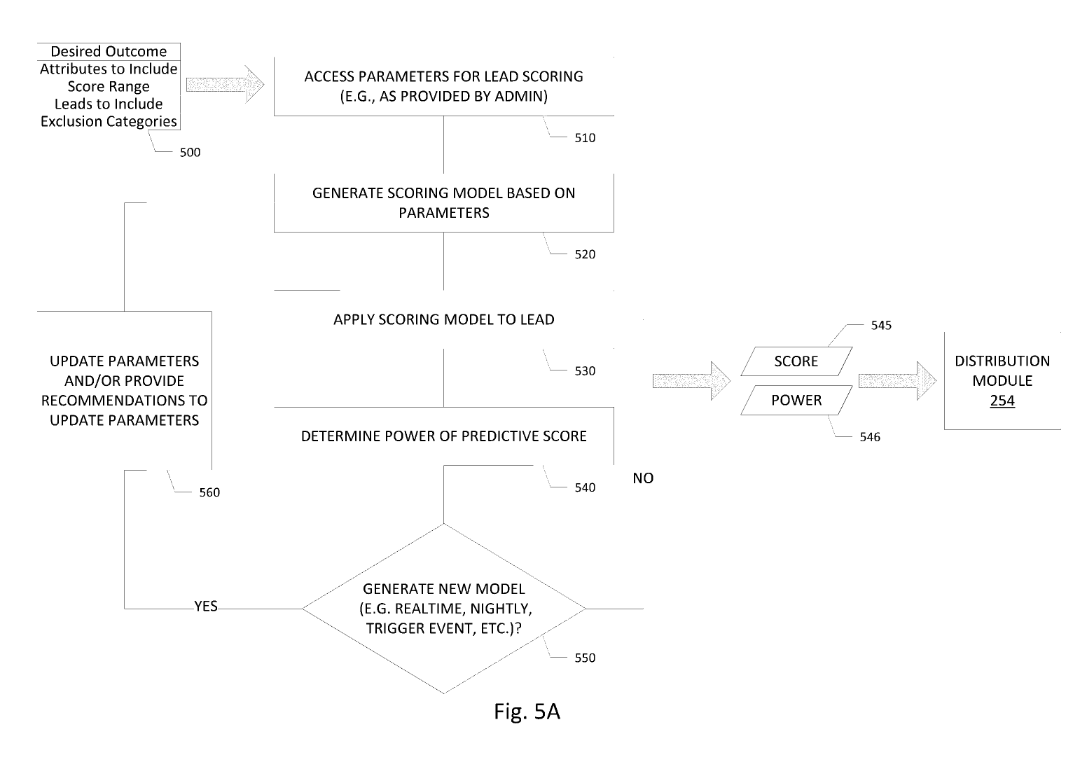

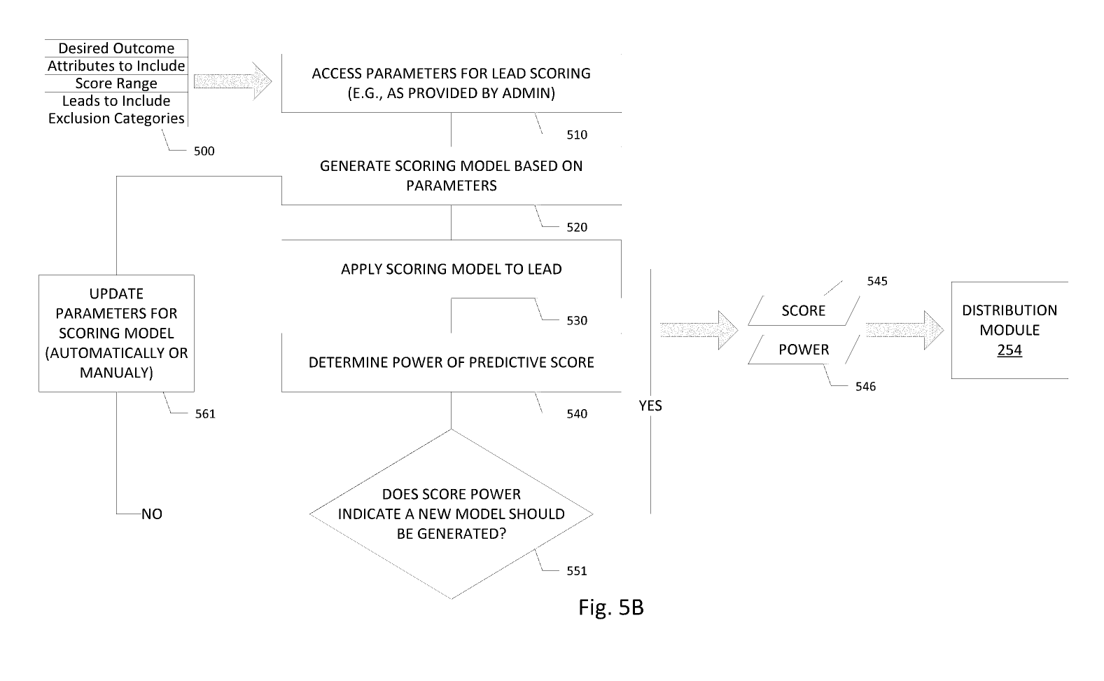

In block 302, the lead scoring system begins the lead evaluation process by accessing a scoring model which is used to evaluate sales leads. The scoring model may be determined based on parameters selected by a system administrator. The lead scoring system may also update the scoring model before scoring the next lead, group of leads, or in response to other events. Examples of accessing and/or updating the scoring model processes are discussed further below in reference to FIGS. 5A and 5B.

The lead scoring system then determines a score for the lead in block 304. The score is determined by applying the model selected and/or updated in block 302 to the attributes of the sales lead. In block 306, the lead scoring system is further configured to determine the power of the score attached to a lead. The score power is indicative of the accuracy of the score provided in block 304. For example, the score power may indicate the quality of the model selected in block 302 as applied to a sales lead in block 304. In some embodiments, if the score power from block 306 is too low, block 302 may update the scoring module. Examples of scoring a sales lead and determining a score power for that score are disclosed further below in reference to embodiments of FIGS. 5A and 5B

In embodiments of the system illustrated in FIG. 3 including a lead distribution system, blocks 308, 310, and 312 illustrate processes which may be performed by the lead distribution system. The lead distribution system may be comprised of a lead distribution module, or of multiple separate modules. For example, the lead distribution system may be comprised of the tiering module 252 and the distribution module 254.

In block 308, the lead distribution system accesses the current distribution program, which may be selected from one or more distribution programs that are currently being serviced by a group of sales agents. The distribution program determines the order in which leads are distributed to sales entities. The lead distribution system may update the distribution program based on performance of sales entities, contact rates, availability, and/or other factors.

In block 310, the lead distribution system (e.g., the tiering module 254) updates the assignment of agents to tiers based on attributes of agents, the distribution program, and/or other attributes. In some embodiments, the lead distribution system may only update the current agent assignments at a set frequency, for example, every night or when beginning a new distribution program, for example. In other embodiments, the lead distribution system may update the agent assignments continuously as new leads are distributed, such as prior to assigning each lead or set number of leads. Other embodiments may update the distribution of sales agents at different intervals, or based on different factors depending on which distribution program is currently selected by the lead distribution system.

In block 312, the lead distribution system distributes the lead, the lead score, and/or the lead score power to the sales agents. In some embodiments, only the lead is distributed to the sales agents. In other embodiments, any combination of the lead, the lead score, and the lead score power may be distributed to the sales agents.

In some embodiments of the lead system 100, there is no lead scoring system, but only a lead distribution system. In such embodiments, the lead distribution system may still distribute leads to sales entities and may perform some or all of blocks 308, 310, and 312. In other embodiments of lead system 100, there is no lead distribution system. In such embodiments, the lead scoring system may perform some or all of blocks 302, 304, and 306, and may provide the leads and lead scores to another entity, for example. For example, in some embodiments of a lead system 100 without a lead distribution system, the lead scoring system may access leads from a server, score them, and return them to a server.

### Example Lead Scoring Methods

The determination of a lead score may be based on anything that the scorer (e.g., the organization that is attempting to sell products/services to leads) deems valuable. Lead scores can be represented in any way that delineates leads into categories, e.g. numbers (e.g. 1 to 100), letters (e.g. A+ to F), roman numerals (e.g. Ito XX), verbal descriptors (e.g. good, bad), etc. Example quality differentiators that sales organizations may be interested in include:
Likelihood that the lead will be contactable
Likelihood that the lead is interested and/or qualified to purchase an organization's product or service
Likelihood that the lead will contribute revenue to the organization
Expected timeframe in which the lead will contribute revenue to the organization
Expected revenue that the lead will contribute to the organization.
The anticipated profitability of the sale to the lead
Expected lifetime value of the lead if they become a customer
   Each organization may have different criteria for determining the above characteristics.

In general, leads can be scored in a heuristic or probabilistic manner, or some combination of the two manners. The scoring module 250 may be configured to perform one or both of the heuristic or probabilistic scoring methods, or some combination of the two.

### Example Heuristic Lead Scoring

In a heuristic methodology, a lead scorer uses past experience, for example, to guide which lead attributes contribute to their desired quality outcome and the relative weighting of each attribute. For example, the scorer (e.g., an individual that reviews revenue generation figures for an organization and/or software that performs such analysis) may decide that the following attributes most delineate the likelihood that a lead will generate revenue for the scorer's organization:
1. Number of times lead has visited the organization's website (perhaps within a certain time period)
2. Income level of the lead (e.g., an estimated income of the lead and/or lead household)
3. Whether or not the lead resides in California

Once the scorer has determined their desired attributes, they may then allocate a relative weighting to each attribute. An example might look like the following:

| Rules (Attribute and value) | Impact on Score |
|---|---|
| Lead has visited website > 5 times | +10 |
| Lead has visited website 3 or 4 times | +5 |
| Lead has visited website 2 or 3 times | +3 |
| Lead has visited website > 1 time | +1 |
| Lead has visited website = 0 times | −1 |
| Lead has income > $250K per annum | +5 |
| Lead has income $100K-$249,999 p.a. | +2 |
| Lead has income $1-$100K | 0 |
| Lead has income = 0 | −10 |
| Lead residence = California | +2 |
| Lead residence <> California | 0 |

In the heuristic method, the “impact on the score” is arbitrary. For example, the above score impacts may be increased (or decreased) by a factor of 2, 5, 10, or 100, for example, in order to yield scores that are within a higher (or lower) scoring range. The scoring module 250 may generate lead scores based on lead attributes of respective leads that increment or decrement the lead score for the leads.

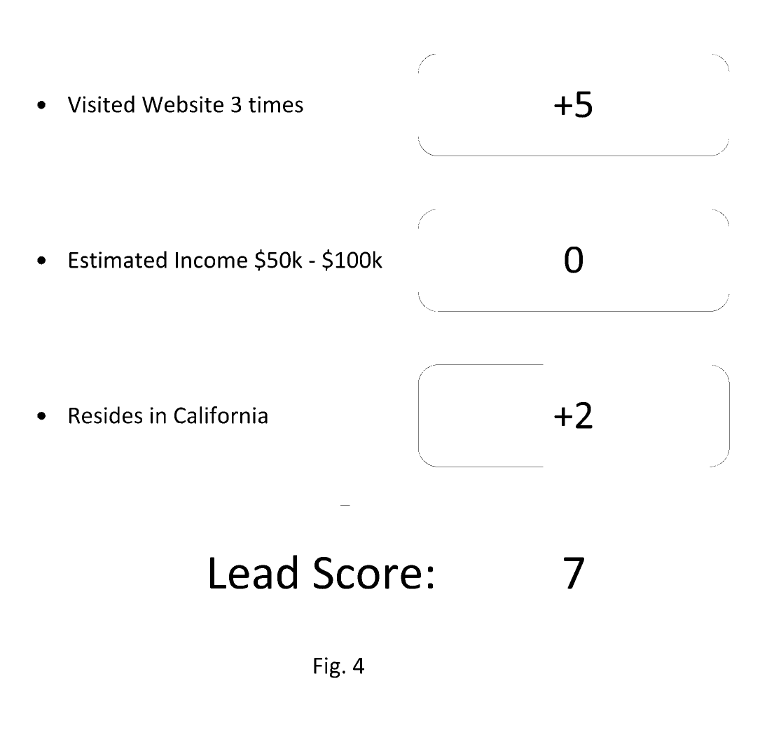

FIG. 4 illustrates an example score for a lead using the sample rules listed above. As shown in FIG. 4, the lead is assigned a score of 7, which is the sum of the +5 impact associated with a lead attribute associated with an individual that has visited the website of the organization (or another entity for which the organization performs lead contacts) three times, +0 impact associated with a lead attribute associated with income level of the lead, and +2 impact associated with an attribute indicating that the lead resides in California.

In examples where the organization wishes to display a value for the score rather than (or in addition to) a number, there may be a number to score translation capability. For example where an organization wishes to describe the lead's score verbally there may be a translation that looks something like the following:

| Total Lead Score | Displayed Score |
|---|---|
| >10 | Excellent |
| 7-9 | Good |
| 5-7 | Average |
| 0-4 | Poor |
| <0 | Bad |

Using this scoring methodology with the example of FIG. 4, the lead having a score of 7 would be assigned a score of “Good.”

### Example Predictive Scoring

In the predictive scoring methodology, the scoring module 250 scores leads according to their statistical likelihood to have a specific outcome based on their similarity to leads for which historical outcomes are known. In some embodiments the scoring module 250 generates more than one score for a particular lead in order to predict the likelihood of different outcomes.

The scoring module 250 may provide an interface by which a user, even a non-technical user, could define the parameters of the predictive algorithm to be used in scoring leads. For example, the user could provide input indicating:
1. The desired outcome
2. Which lead attributes should be considered in the scoring algorithm
3. The desired range of the score
4. The cohort of leads that should be used to generate the score, e.g. the range of dates of received leads,

The scoring module 250 may then analyze the data in the cohort of leads to determine if there is a statistically relevant sample size. If the sample size is not large enough, the scoring module 250 may provide the user with specific feedback about what parameters may be changed in order to create a statistically relevant sample. The cohort of leads include historic leads which have already been contacted and reached a resolution, which may be referred to as having an outcome. Outcomes may include, for example, the lead was successfully contacted, a sale was made to the lead, a lead declined to purchase, a lead could not be contacted, a lead progressed to the next sales status, the total revenue generated from a lead, or other events indicative of status of communications with a lead. As new leads are contacted and converted or abandoned, they may be added to the cohort of historic leads to generate more accurate models for later leads.

Following this the scoring module 250 may perform a statistical calculation to generate a model which can be applied to leads to determine a score for the leads. One such statistical calculation may include a stepwise multivariate regression, which may first remove any attributes from the regression that did not add to the predictive power of the resultant linear equation. The linear equation that the regression generates may be in the following form.

Y=a+b1*X1+b2*X2+ . . . +bp*Xp

Where a represents the dependent variable otherwise known as the intended outcome, X represents independent variables describing the attributes that are relevant to the probability scoring and the b variables describe the relative weighting of variables in the score. The weightings may be determined by comparing values of independent variables with the intended outcome. When this analysis is performed for a large enough sample size of historic leads, an accurate model may be generated. For example, the following linear equation indicates that the scoring module 250 has determined that the relative scoring should weight income, state being California and the number of website visits that the lead has made in the ratio of 1:2:5, as follows:

Y=0.2+0.1*Income+0.2*State is California+0.5*Website Visits

Further based on the values of those attributes in the cohort the scoring module 250 may determine appropriate ranges for each attribute. For example, for State is California the relevant values might be “yes” and “no” (which the scoring module 250 may have already converted to binary 0 and 1). In this case a score impact of 0 might be attributed to any lead that did not reside in California and a score impact of 2 might be attributed to any lead that did reside in California.

In one embodiment, once the scoring module 250 has determined the scoring attributes and associated weights, the scoring module 250 may present the end user with one or more of:
The scoring methodology
The power of the score
The ability to choose the frequency that the score will refresh

In one embodiment, the scoring methodology describes the weightings placed on attributes, such as, for example:

| Attribute | Weight |
|---|---|
| website visits | .5 |
| State | .2 |
| Income | .1 |

The power of the score may utilize the correlation coefficient represented by an r-value to make a determination of the closeness of the linear regression equation to the observed values in the data set. Put another way, the r-value may be an indicator of the predictive power of the lead score. The score power may be determined based on actual outcomes of leads that were previously scored. For example, a scoring model may predict the likelihood of an intended outcome for sales leads. In such a model, the lead system may apply the generated model to historical leads with attributes matching the parameters used to generate the scoring model and data on the actual outcome. The system can then compare the predicted outcome for scored leads with the actual outcome for those historical leads. If the predicted outcome from the model correlates highly to actual outcome of historical sales leads, then the r-value may be close to ±1. However, if the predictive scores determined by the model correlate poorly with the actual outcomes of historical sales leads, then the r-value may be closer to zero.

If the model generated by the scoring module produces a low r-value or score power, it may be because the parameters and/or lead attributes used by the scoring module to generate the model are poor indicators of the outcome. In such circumstances, the scoring model may update parameters or recommend parameters for a user to update, either automatically and/or manually. While r-values and other statistics have meaning to a statistician, they are not readily recognizable to all sales agents or other users who may be making decisions as to which parameters and attributes to include when generating a scoring model. To make the r-value relevant to the majority of users it may be translated into easy to understand score or language, such as

| r-value | Description for user |
|---|---|
| +/−0.8-1.00 | Extremely strong scoring method |
| +/−0.7-0.79 | Strong scoring method |
| +/−0.5-0.69 | Adequate scoring method |
| +/−0.2-0.49 | Weak scoring method |
| +/−0-0.19 | Inadequately weak scoring method |

In some embodiments, the scoring module 250 may provide specific suggestions on how to alter parameters such as improving the dataset in order to strengthen the scoring method's predictive power.

In some embodiments, the scoring module 250 may set intervals at which the scoring methodology refreshes. This could be any time period desired including every time any data changed (which in most systems would be practically continuously). In this way the scoring methodology could be kept relevant as the patterns in what makes a “good” lead change over time, without a user having to continuously re-run the program.

FIG. 5A is a flowchart illustrating one embodiment of an example lead scoring method. In one embodiment, the method is performed by the scoring module 250. However, the method may be performed by other modules and/or other suitable computing devices. Depending on the embodiment, the method of FIG. 5A may include fewer or additional blocks and/or the blocks may be performed in a different order than is illustrated.

Beginning in block 510, the scoring module 250 accesses parameters for lead scoring, such as parameters that have been established by a system administrator (e.g., an individual that reviews previously generated lead scores and corresponding outcomes in order to determine parameters to be included in the scoring, or an automated software process that performs a similar analysis). For example, the parameters that may be selected for inclusion in a lead scoring algorithm/model may include desired outcome, lead attributes to include, score range, leads to include in the analysis, one or more categories of leads to exclude, and/or other parameters. In other embodiments, fewer and/or additional parameters may be selected for inclusion in a lead scoring model.

Next, in block 520, the scoring module 250 generates a scoring model based on the selected parameters as discussed above.

Moving to block 530, the scoring model generated in block 520 is applied to one or more leads that are presented for scoring (e.g., leads received at an organization that desires to contact the leads in a most efficient manner). In one embodiment, the scoring module 250 provides a lead score to the lead distribution module 256, which may be configured to distribute the leads to a most appropriate entity based on the generated lead score and/or other factors, such as tiering of the entities. In some embodiments, the scoring module 250 is configured to provide multiple scores for a single lead. These scores may be distributed to an entity along with the lead itself or may be used when determining which sales agent a lead should be distributed to. These scores may provide predictions or valuations of various attributes that are not obvious from the lead attributes. For instance, there may be different scores for likelihood the lead is contactable, likelihood the lead is interested and/or qualified to purchase an organization's product, likelihood the lead will contribute revenue to the organization, expected timeframe in which the lead will contribute revenue to the organization, expected revenue that the lead will contribute to the organization, expected profit from the lead, expected lifetime value of the lead if they become a customer, and/or other attributes of the lead that may be interesting.

In some embodiments, the scoring module 250 also provides a score power 546, which indicates the predictive power of the generated score. The score power may be calculated in block 540. The score power may indicate to an organization that the parameters to be included in the scoring model should be adjusted. For example, if the score power is very low, the parameters selected for inclusion in the score model may not be optimal. For instance, the parameters may not include enough leads for the model to be accurate, or the attributes considered for each lead when generating a model may not be the attributes most correlated with an intended outcome. The score power may also be passed along to the distribution module to be used in distribution of leads and/or distributed to the assigned sales entity. The entity may consider the score power alongside the score itself to determine if the score is sufficient to be relied upon when deciding how to contact leads.

In some embodiments the scoring model generates a new model automatically. In block 550 the scoring module determines if it is an appropriate time to update the scoring model. How often the scoring model is updated may depend on the importance of accuracy in the scoring model, the volatility of the attributes likely to affect the scoring model, the intended outcome, the frequency of new data which would affect the scoring model, the distribution program, and/or other factors.

In some embodiments of the scoring module, leads are tracked after distribution to sales entities. Therefore, new data may be received after leads reach a new stage, such as completing an order, adding to a callback list, or abandoning the lead. For example, if a lead is converted and a sale is made, new data is available about that lead. Other new data which may be tracked can include revenue from the lead, time to conversion, contactability, profitability, or any other factors of interest throughout the sales process.

In block 550, the scoring module 250 determines if a new scoring model should be generated. As discussed above, the scoring model may be generated each time new data is received, such that the scoring model applied to any particular lead is always the most predictive (e.g. based on the most current lead performance data). In other embodiments, the scoring model may be updated on a periodic schedule, such as nightly, weekly, monthly, or quarterly, for example. In other embodiments, the scoring model may be updated in response to a trigger event, such as receiving leads from a particular entity, leads with a particular quality, etc. In some embodiments, the scoring model may be updated when a new set of leads is received.

FIG. 5B is a flowchart illustrating an embodiment of the lead scoring method similar to FIG. 5A, but wherein block 551 and 561 replace blocks 550 and 560. In this embodiment the decision whether or not to generate a new model or change parameters is determined based on the predictive score power. If the scoring module determines at block 551 that the predictive score power is too low, it may trigger the system to update the parameters and generate a new scoring model. In some embodiments block 551 will have a preset accuracy which it requires of the lead scoring system in order to return to block 530 without updating the scoring model. In other embodiments, the lead scoring system will monitor the score power and determine if the score power indicates the need for a new scoring model based on past score powers. For example, if the scoring module determines that the score power is decreasing (e.g., a certain percentage decrease over a certain time period), the system may determine it is necessary to update parameters and/or generate a new scoring model.

If the scoring module determines at block 551 that a new model is to be generated (or the existing model is to be updated), the method continues to block 560 (FIG. 5A) or 561 (FIG. 5B) wherein the scoring module 250 provides suggestions for changes to the parameters used in generating the scoring model in order to optimize the score power, and/or the scoring module 250 automatically updates the parameters in order to optimize the score power. In some embodiments, blocks 560 and 561 are not present and the system returns to block 520 to generate a new model without considering changing parameters. In the embodiment illustrated in FIG. 5B, block 561 performs the process of updating parameters when the predictive score power indicates to the system that the scoring model needs to be updated (as determined at block 551, for example).

The method then returns to block 520 where the scoring model is generated based on the predefined parameters (or updated parameters in some embodiments), and leads are scored using the updated scoring model in block 530. If, however, a new model is not to be generated in block 550 or, the method continues to block 530 where another lead is scored using the previously generated scoring model. The lead scoring system will continue to use the same scoring model until an update is required by the system.

### Lead Distribution

Leads may be distributed based on, among other things, a type of lead and/or eligibility of the entity being considered for distribution. The type of lead can be based on one or more lead attributes. Attributes may be associated with lead variables e.g. “location of residence”, the source of the lead e.g. “campaign X”, the stage a lead is in e.g. “contacted once”, or activities the entity a lead represents has undertaken e.g. “visited website twice”.

In one embodiment, a lead type may be based on the lead score. Thus, the distribution module 256 may distribute leads differently according to their scores.

Depending on the embodiment, an entity's eligibility for receiving a lead can be based on a distribution program including one or more characteristics, including, for example:
Lead characteristics. A certain entity may be eligible for only leads with certain lead attributes. For example, a user may only be allowed to receive leads who reside in the state of New York or leads that have a certain lead score.
Volume of leads distributed historically. A certain entity may be limited to a certain number of leads over a period of time. Once this threshold is reached, they may no longer receive more leads during that period of time.
Entity performance. In embodiments wherein outcome of a lead is monitored and outcome is determined, the relative performance both of the leads themselves and the entities to which the leads were assigned may be used to determine how leads are distributed. For example, entities may be placed in tiers (discussed further below) that receive leads having different attributes in different quantities, orders, etc.
Timing. Entities may have schedules for receiving leads and/or the distribution system may have realtime data indicating availability of an entity to receive leads. Each distribution program may be defined to only distribute leads at certain times and the lead system 100 allows the organization and/or entities to define the times at which each entity is able to receive leads.

### Distribution Using Tiers

In one embodiment, the tiering module 254 is configured to place entities (e.g., sales agents) in performance threshold tiers associated with the outcome desired for a particular distribution program (or multiple distribution programs). For example, tiers may be segmented based on one or more of contact rate, application rate, conversion rate, revenue, profit, lifetime value, etc. Below is one example of tiers associated with contact rates.

| Tier | Contact Rate |
|---|---|
| Tier 1 | >25% |
| Tier 2 | 10%-24.99% |
| Tier 3 | <10% |

Leads may also be distributed based on the desired outcome and time period, such as a distribution program that distributes, for example, “all leads with an income of >$100 K received over the past 3 months” to entities in tier 1.

In some embodiments, leads are distributed based on the performance level of entities for leads with particular attributes. For example, if one sales agent converts 60% of leads for a particular product that sales agent may be placed into the first tier of a distribution program for that product, but may be in a lower tier for another distribution program. A second sales agent may convert only 25% of his leads for that product and may therefore be placed into a lower tier for the distribution program for that product. The agents in the top tiers may receive more leads for that product because they are more likely to convert the sales. Thus, in some embodiments, tier requirements and/or tier assignments are specific to a distribution program, a product/service that is part of a distribution program, an entity requesting the distribution program, and/or other attributes related to the distribution program. Accordingly, as noted in the example above, a sales agent may be in the top tier for leads relating to a particular distribution program, but in the bottom tier for leads relating to another distribution program.

The type of lead associated with a distribution program may be optimized through a program that determines which lead characteristics provide the best basis for differentiated performance across the dataset. For instance, a distribution program may suggest performance-based distribution for leads based on the state of residence because there is a high level of variability in performance across the different entities being distributed leads.

Once the tiers are set, the user defining the distribution program and/or the tiering module 256 may determine how leads are to be allocated between tiers. This could be either via a ratio/percentage or as a cap over a time period. As shown in the example below, a distribution ratio between tiers is established so that for every 5 leads distributed to tier 1 entities, 3 leads are distributed to each tier 2 entity, and 1 lead is distributed to each tier 3 entity.

| Tier | Allocation Ratio |
|---|---|
| 1 | 5 |
| 2 | 3 |
| 3 | 1 |

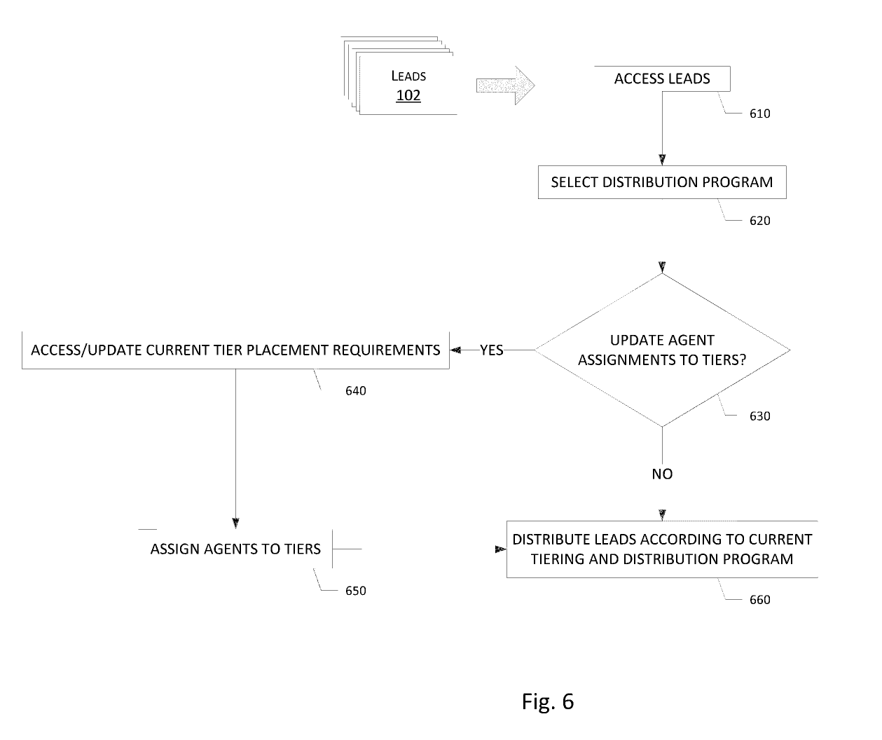

FIG. 6 is a flowchart illustrating one embodiment of a method of distributing leads. The method of FIG. 6 may be performed by the distribution module 256 and/or any other suitable module or computing system. Depending on the embodiment, the method of FIG. 6 may include fewer or additional blocks and/or the blocks may be performed in a different order than is illustrated.

Beginning in block 610, the lead distribution module accesses the leads 102 to be distributed. For example, leads that have been scored by the scoring module (e.g., using processes of FIG. 5A or 5B) may be received by the distribution module and/or may be accessed at a network location. Alternatively, leads that have not been scored by the scoring module may be accessed for distribution.

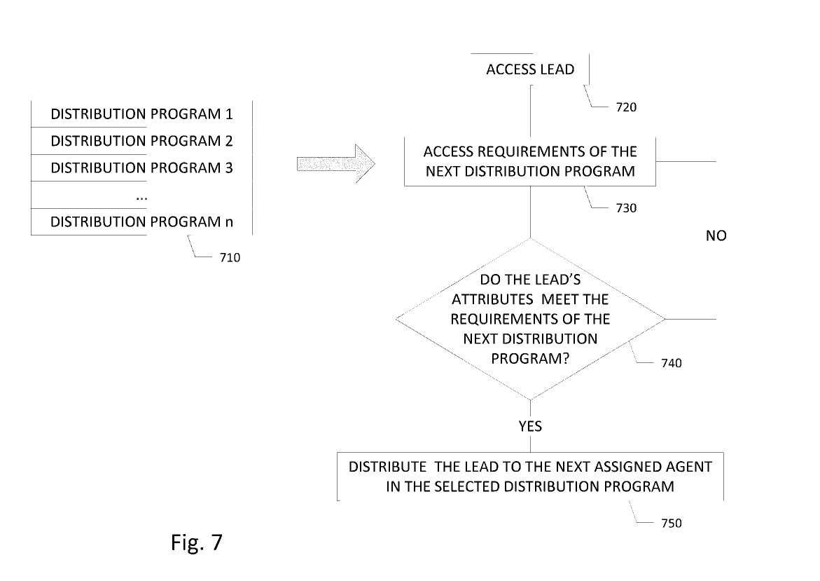

In block 620, the lead distribution module selects which distribution program to use for distributing one or more accessed leads. One example process of selecting which distribution program to use is discussed with reference to FIG. 7, below. However, any other method for selecting the appropriate distribution program for a lead or set of leads may be used.

Moving on to block 630, the lead distribution system determines whether to update the assignment of entities to tiers for the given distribution program. In some embodiments agents are reassigned at a given time interval, such as nightly, hourly, or weekly. In other embodiments agents are reassigned based on other trigger events, such as each time a set number of leads are distributed to a particular distribution program (e.g., after distributing each 20 leads using a particular distribution program).

If the selected distribution program does not need to be updated, the method moves on to block 660 where the distribution module distributes lead(s) according to the current tiering and distribution program. While FIG. 6 demonstrates checking whether agent assignments need to be updated after a distribution program is selected, in some embodiments the module for updating agent assignments for distribution programs is separate from the module which selects distribution programs and distributes leads.

If the lead distribution module determines in block 630 to update entity assignments for a distribution program, it moves on to block 640. In block 640 the lead distribution module determines if the tier placement requirements for the tiers in the distribution program need to be updated. For example, a particular distribution program may require a conversion rate of 60% for assignment to tier 1. However, the lead distribution system may decide that an updated conversion rate of 65% should be required for assignment to tier 1, for example, if too many agents were being assigned to tier 1 under the previous program.

Moving on to block 650, after the lead distribution system accesses or updates the tier placement requirements for the selected distribution program, the lead distribution module assigns entities to tiers based on the current tier placement requirements.

In block 660, the lead distribution system distributes leads according to the new updated tiering and distribution program. In some embodiments, the leads are assigned to tiers by the distribution module 256 and another program is used to assign leads to specific entities within the tiers (e.g., based on current availability of agents assigned to the tier). Alternatively, the distribution module 256 may distribute the leads directly to the entities (e.g., sales agents).

The method illustrated in FIG. 6 may be implemented on individual leads, or on groups of leads. For example, each time a lead is to be distributed, the lead distribution module may select a distribution program in block 620, updated the distribution program in blocks 630, 640, and assign agents in block 650. In other embodiments, the lead distribution module may access leads in batches. In such embodiments, the distribution module may select one distribution program for the entire batch of leads in block 620, and distribute the batch of leads according to the selected distribution program.

FIG. 7 illustrates one embodiment of a process used to select the distribution program to be used for a particular lead, such as may be performed in block 620 of FIG. 6. Block 710 represents a set of distribution programs available to the lead distribution system. In some embodiments the distribution programs are organized into a prioritized order, so that the first distribution program in the set is the program most preferred by the system. Starting in block 720, the lead distribution system accesses a lead to be distributed. The attributes of the lead will determine which distribution program the system will select. In block 730, the lead distribution system accesses the requirements of the next distribution program on the list. A distribution program may have one or more requirements. For example, a distribution program may have requirements as to which product the lead is associated with, the state of residence of the lead, the estimated income of the lead, the contactability of the lead, the lead score associated with the lead, and/or other lead attributes

In block 740, the lead distribution system compares the attributes of the lead to the requirements of the distribution program. If the lead's attributes meet the requirements of the distribution program, then in block 750 the lead is distributed to the next agent assigned to receive a lead in that distribution program. If the lead's attributes do not meet the requirements of the distribution program, the process returns to block 730 and accesses the requirements of the next distribution program. The process will continue until a suitable distribution program is selected, and then the lead will be distributed in block 750. FIG. 7 illustrates one example of a method for the selection of a lead distribution program. Other embodiments may also be used. For example, in some embodiments the distribution programs are not ordered in a prioritized order, and the process does not go through the list in order.

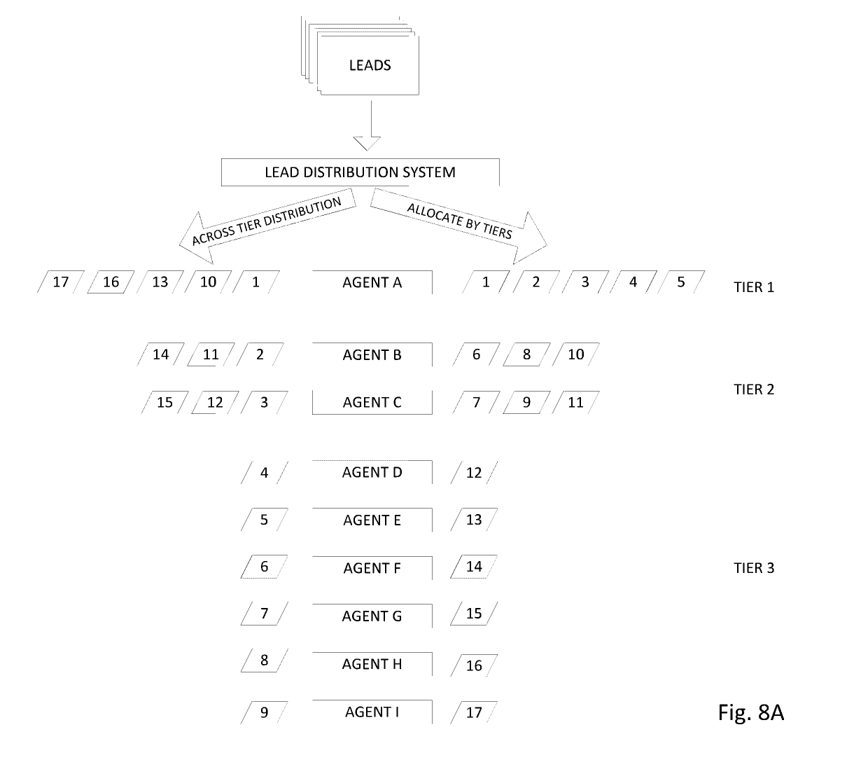

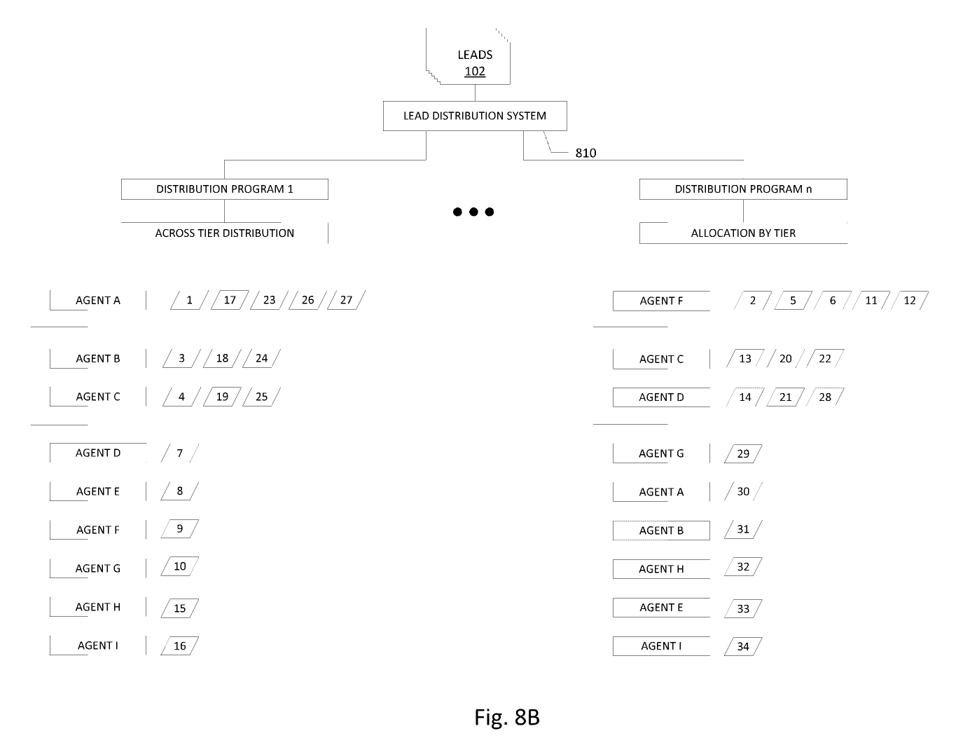

Depending on the embodiment, leads may be distributed to entities across tiers in various manners. FIG. 8A illustrates the distribution of leads using two different distribution programs (and their accompanying distribution models) among the same tiers and the agent assignments within tiers. In this example, tier 1 includes only one agent (agent A), tier 2 includes two agents (agents B and C), and tier 3 includes six agents (agents D-I). In this embodiment, the distribution program is to distribute leads in the ratio of 5:3:1 to agents within tiers 1, 2, and 3. However, the order in which the leads are distributed may vary based on the selected distribution model (e.g., by the company that initiated the marketing campaign and/or by a sales call center or other administrator). For example, distribution using the “allocate by tiers” distribution model illustrated to the right of the agents in FIG. 6 results in distribution of the first five leads to Agent A, which may be enough leads to keep the agent busy for some time and may result in leads not being contacted promptly. Similarly, three leads are next assigned to each of the tier 2 agents and, finally, the last 6 leads of the set are assigned to the tier 3 agents. Such distribution of leads may result in an unbalanced workload between agents of the three tiers.

In contrast, the “across tier distribution” model illustrated to the left of the agents may result in a more efficient use of agents across the three tiers. In this distribution model, a single lead is assigned to agents in each tier before another lead is assigned to other tiers. Thus, each of the nine illustrated agents receives a lead before a second lead is distributed to the agents in tier 1. In this way, the time of the agents may be better utilized and leads may be contacted in a more efficient manner. In a variation of this distribution model, any other quantity of leads may be distributed to each tier before distributing to the next tier. For example, two leads may be distributed to each agent in the first tier, followed by two to each agent in the second tier, and two to each agent in the third tier (or, if the tier ratio indicates fewer leads should be distributed to a tier, the quantity may be limited by that ratio).

FIG. 8B illustrates an example distribution of leads across multiple distribution programs. In FIG. 8B the first distribution program uses an across tier distribution model, while Distribution Program n uses an allocation by tier distribution model. Thus, each of the multiple distribution programs that may receive leads may have unique tier configurations and/or distribution models.

In the example from FIG. 8B, leads 102 are accessed by the lead distribution system 810, such as when a consumer calls into a call center, a lead list is sent from a customer of the call center, or otherwise. The lead distribution system 810 selects the distribution program most appropriate for each lead (or group of leads in some embodiments) based on the lead's attributes, such as by using the method described above in reference to FIGS. 6 and 7. The leads are then distributed based on parameters of the selected distribution programs. In this example there is a plurality of distribution programs, for simplicity, only distribution program 1 and distribution program n are shown. In some embodiments there may be many distribution programs, and leads may be distributed among any number of them. The lead distribution system 810 in FIG. 8B illustrates the distribution of 34 leads among two distribution programs. In this example, some agents are assigned to different tiers in distribution program 1 than in distribution program N. Agent A is assigned to tier 1 in distribution program 1, but is assigned to tier 3 in distribution program n, for example. In some embodiments, within each tier agents are ranked by their performance. Therefore, the highest performing agents may receive leads before the less qualified agents within a particular tier.

In this example, both distribution program 1 and n have three tiers, but some distribution programs may have fewer or additional tiers. Distribution program 1 could have 4 tiers while distribution program n only had 2 tiers, for example. Furthermore, distribution programs may have different distribution ratios. For example, rather than the illustrated 5-3-1 ratio used by distribution programs 1 and n, a ratio of 6-3-2; 7-5-3-1 (for a four tier system); 3-1 (for a two tier system), and the like may be used. Furthermore, in some embodiments, there may be a different number of agents per tier in some distribution programs. For example, a distribution program may have 2 agents in tier 1, 3 agents in tier 2, and 7 agents in tier 3. Some distribution programs may also completely exclude some agents from some tiers and/or programs.

In some embodiments of the lead distribution system, distribution programs need not group agents into tiers. Instead agents may be organized into order based on their individual performance, and leads may be distributed at a higher volume to those agents closer to the top of the performance rankings.

### Performance-Based Distribution Program Optimization

In some embodiment, performance-based distribution is intended to be inherently self-optimizing in that leads are distributed according to the dynamic changes in performance of those entities being distributed to (put another way, as an entities performance relative to their peers changes, the performance tier they are in can change). For example, referring back to FIG. 6, the setting of tiers (block 640) and assignment of entities to tiers (block 650) may occur on an ongoing (e.g., realtime) basis, periodically, or in response to one or more trigger events in order to reallocate entities to tiers that are reflective of most recent performance.

### Using Comparative Advantage to Create Performance-based Distribution Programs

The calculations described by David Ricardo that describe how to determine the comparative advantage of nations in producing goods may be utilized by the lead system 100 to recommend how performance-based distribution programs are structured. In this scenario, the lead system may look at lead characteristic criteria for programs where one group of entities has a comparative advantage over another.

### Other

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

Each of the processes, methods, and algorithms described in the preceding sections may be embodied in, and fully or partially automated by, code modules executed by one or more computer systems or computer processors comprising computer hardware. For example, the methods described herein may be performed by the CPU system 250 and/or any other suitable computing device. The code modules may be stored on any type of non-transitory computer-readable medium or computer storage device, such as hard drives, solid state memory, optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of tangible and/or non-transitory computer storage such as, e.g., volatile or non-volatile storage. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A computing system for distributing sales leads, wherein the computing system comprises:
one or more hardware computer processors;
one or more storage devices configured to store software instructions configured for execution by the one or more hardware computer processors in order to cause the computing system to:
determine one or more attributes of a sales lead;
access respective parameters of each of a plurality of distribution programs, the parameters including:
one or more required lead attributes of sales leads to be eligible for the corresponding distribution program;
tier configuration attributes indicating at least a quantity of tiers and requirements for membership of sales entities within corresponding tiers;
one or more lead distribution models indicating in what manner incoming leads are distributed among tiers and/or among sales entities within tiers;
wherein at least one of the distribution models indicates distribution of consecutive sales leads to sales entities in different tiers;
select a distribution program of the plurality of distribution programs based on the one or more attributes of the sales lead matching the required lead attributes of the selected distribution program; and
distribute the sales lead to a tier of sales entities based on a lead distribution model associated with the selected distribution program.

2. The computing system of claim 1 wherein the lead distribution programs are prioritized and said selecting the distribution program selects a highest priority distribution program in response to the one or more attributes of the sales lead matching required lead attributes of two or more distribution programs.

3. The computing system of claim 1 wherein distributing the sales lead further comprises distributing the sales lead to a sales entity in the tier of sales entities.

4. The computing system of claim 1 wherein the tier configuration attributes further indicate a ratio of leads to distribute to each tier.

5. The computing system of claim 1 wherein one of the attributes of the sales lead is a lead score indicating an intended outcome for the lead.

6. The computing system of claim 1 wherein the distribution model indicating distribution of consecutive sales leads to sales entities in different tiers further comprises distributing a lead to each sales entity in the distribution program before distributing a second lead to any sales entity.

7. The computing system of claim 1 wherein the sales entities are placed into tiers based on attributes of the sales entities and according to the requirements for membership of the tiers for the selected distribution program.

8. The computing system of claim 7 wherein a sales entity is assigned to a first tier for a first distribution program, and to a second tier for a second distribution program.

9. The computing system of claim 7 wherein the tier configuration attributes indicate at least a first tier and a second tier, wherein membership into the first tier requires a higher sales performance attribute of sales entities than is required for membership in the second tier.

10. The computing system of claim 1 wherein the computing system is further configured to determine if the distribution program should be updated, wherein, updating the distribution program comprises updating tier membership requirements and/or updating assignment of sales entities within the tiers.

11. The computing system of claim 10 wherein said determining if the distribution program should be updated is based on one or more of: time since last update, nature of the distribution program, attributes of sales entities in the distribution program, availability of sales entities, or number of leads distributed since last update.

12. The computing system of claim 10 wherein the computing system is further configured to update the distribution program each time a sales lead is distributed.
